(19) United States
(12) Patent Application Publication
(10) Pub. No.: US 2003/0068485 A1
(43) Pub. Date: Apr. 10, 2003

(54) Termite-resistant foam article

(76) Inventor: William J. Ramsey, Tallmadge, OH (US)

Correspondence Address: OWENS CORNING, 2790 COLUMBUS ROAD, GRANVILLE, OH, 43023, US

(21) Appl. No.: 10/245,989

(22) Filed: Sep. 18, 2002

Related U.S. Application Data
(63) Continuation-in-part of application No. 09/966,457, filed on Sep. 28, 2001, now abandoned.

(51) Int. Cl. B32B 3/00; B32B 3/26; B32B 9/00

(52) U.S. Cl. 428/318.4; 428/314.4; 428/312.2; 428/312.6; 428/312.8

(57) ABSTRACT

An insect resistant extruded or expanded polystyrene foam boards containing from 2 to 25 weight-% acicular particles such as fiberglass, stone wool, metal wool, gypsum, quartz and wollastonite, and insulation panels made from such boards. The fibers are preferably milled or chopped and range in size from 0.0156 inch (0.396 mm) inch to 0.5 inch (12.7 mm) in length and 10 to 20 micrometers in diameter.

### FIELD OF THE INVENTION

This invention relates to polymeric foam structures that are configured as insulation panels and that are compounded to resist termite infestation.

### BACKGROUND OF THE INVENTION

Termites constitute a problem well known to homeowners in all but the coldest parts of the United States. A typical termite species of concern is Reticulitermes flavipes, the Eastern Subterranean Termite. Typical signs of termite infestations include swarming of winged adults in the spring and occasionally fall. A swarm is a group of adult male and female reproductives that leave their nest to establish a new colony. Other signs of termite presence include pencil-sized mud tubes constructed over the surface of foundation walls, mud protruding from cracks between boards and beams, and hollow sounds from infested wood when it is tapped. Termites feed slowly, but inexorably.

Subterranean termites are social insects that live in nest or colonies in the soil. Each colony consists of three forms of individuals: the reproductives, the workers, and the soldiers. A mature termite queen can lay thousands of eggs each year. Termites live in nests underground and tunnel up for food, which includes the wood understructure of houses. Workers need high humidity to survive, and will carry mud up into the wood where feeding to maintain a 97% relative humidity. Workers build mud tubes from the soil to the wood in structures on which they feed. Termites can feed on wood since they have protozoans in their alimentary tract that digests cellulose, a basic component of wood.

Polymeric foam products are used throughout the building construction industry for thermal insulation purposes as well as for cushioning materials, vibration damping materials, isolation joint filler, sill plate and closure gaskets, etc. These polymeric foams do not provide nutritional value to attract and support termites. Termites in search of food may attack the polymeric foam, as it is an easy medium to tunnel through.

It is known to surface-treat construction materials with insecticides to kill termites and other insects that may come into contact with or ingest the treated surface material. The insecticide may leach out of the materials or degrade in the presence of air, water, or light, thereby limiting their long-term efficacy. Also, despite the mortality of the initial attack, termites or other insects may continue past the surface and burrow into the construction materials. The resulting infestation by insects can destroy the physical properties of the foam, rendering it unfit for its intended function.

Recently, some aspects of these problems were addressed by the incorporation of a pyrethrum compound into the polymer matrix. See for example U.S. Pat. No. 6,156,328.

### SUMMARY OF THE INVENTION

The present invention provides another approach to the problem of how to make polymer foam construction materials termite resistant. Instead of incorporating an insecticidal compound into the foam, the present invention incorporates fiberglass particles into the foam. As demonstrated herein below, this enables the production of termite-resistant construction materials without the necessity for using an expensive and by definition toxic insecticide.

Accordingly, this invention provides a polymer foam board comprising from 2 to 25 weight-% fiberglass particles. These fiberglass particles are preferably fibers ranging in size from 0.0156 inch (0.396 mm) to 0.5 inch (12.7 mm) in length and from 10 to 20 micrometers in diameter. The fiberglass fibers preferably comprise from 5 to 10 weight-% of the board. A preferred polymer foam board of this invention is a closed cell expanded or extruded polystyrene foam having a thickness of at least 0.5 inch (12.7 mm) and an average cell size of at least 0.1 mm and up to 3 mm, as measured by ASTM D-3576. The density of the foam ranges from 8 to 80 kg/m³, preferably from 21.6 to 32 kg/m³. In accordance with another preferred aspect of the present invention, the polymer board is configured as an insulation panel.

Advantages of the present invention will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

FIG. 1 presents a front view of a test fixture used to demonstrate the termite resistant property of the polymer foam sheets of this invention.

FIG. 2 presents a side view of a test fixture used to demonstrate the termite resistant property of the polymer foam sheets of this invention.

### DETAILED DESCRIPTION OF THE INVENTION

A primary object of the present invention is to provide a polymer foam board that operates as an insulation panel but that also resists attack by termites.

The foam board of this invention is preferably a rigid extruded or expanded polystyrene foam board, prepared by conventional processes. In the case of extruded polystyrene foam, acicular particles such as fiberglass particles may be introduced as an additive to the extrusion process. Naturally occurring minerals with fibrous characteristics similar to fiberglass are, for example, gypsum (Satin Spar variety), Chalcedony (quartz) and wollastonite. In sufficient quantity minerals of this structure will be as irritating to insects as fiberglass. Acicular man made fibers, including metallic wools such as steel wool, are also quite irritating to soft bodied insects. In the case of expanded polystyrene foams, the acicular particles may be mixed with beads during the normal molding process. Alternatively, the fiberglass particles may be mixed with the polystyrene by the plastics manufacturer prior to extrusion or expansion.

The rigid foamed plastic materials may be any such materials suitable to make polymer foams, which include polyolefins, polyvinylchloride, polycarbonates, polyetherimides, polyamides, polyesters, polyvinylidene chloride, polymethylmethacrylate, polyurethanes, polyurea, phenol-formaldehyde, polyisocyanurates, phenolics, copolymers and terpolymers of the foregoing, thermoplastic polymer blends and the like. Suitable polyolefins include polyethylene and polypropylene, and ethylene copolymers.

A preferred thermoplastic polymer comprises an alkenyl aromatic polymer material. Suitable alkenyl aromatic polymer materials include alkenyl aromatic homopolymers and copolymers of alkenyl aromatic compounds and copolymerizable ethylenically unsaturated co-monomers. The alkenyl aromatic polymer material may further include minor proportions of non-alkenyl aromatic polymers. The alkenyl aromatic polymer material may be comprised solely of one or more alkenyl aromatic homopolymers, one or more alkenyl aromatic copolymers, a blend of one or more of each of alkenyl aromatic homopolymers and copolymers, or blends of any of the foregoing with a non-alkenyl aromatic polymer.

Suitable alkenyl aromatic polymers include those derived from alkenyl aromatic compounds such as styrene, alphamethylstyrene, ethylstyrene, vinyl benzene, vinyl toluene, chlorostyrene, and bromostyrene. A preferred alkenyl aromatic polymer is polystyrene. Minor amounts of monoethylenically unsaturated compounds such as C₂₋₆ alkyl acids and esters, ionomeric derivatives, and C₄₋₆ dienes may be copolymerized with alkenyl aromatic compounds. Examples of copolymerizable compounds include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Typical polymer blends comprise substantially (that is, greater than 95 percent) and most preferably entirely of polystyrene. The present invention relates to a process for preparing a foam product involving the steps of forming a foamable mixture of (1) polymers having weight-average molecular weights from about 30,000 to about 500,000. In one embodiment, the polystyrene has weight-average molecular weight about 250,000, and (2) compounding additives, (3) a blowing agent, (4) other process additives, such as a nucleation agent, flame retardant chemicals, foaming the mixture in a region of atmosphere or reduced pressure to form the foam product.

Any suitable blowing agent may be used in the practice on this invention. Blowing agents useful in the practice of this invention include inorganic agents, organic blowing agents and chemical blowing agents. Suitable inorganic blowing agents include carbon dioxide, nitrogen, argon, water, air, nitrogen, and helium. Organic blowing agents include aliphatic hydrocarbons having 1-9 carbon atoms, aliphatic alcohols having 1-3 carbon atoms, and fully and partially halogenated aliphatic hydrocarbons having 1-4 carbon atoms. Aliphatic hydrocarbons include methane, ethane, propane, n-butane, isobutane, n-pentane, isopentane, and neopentane. Aliphatic alcohols include, methanol, ethanol, n-propanol, and isopropanol. Fully and partially halogenated aliphatic hydrocarbons include fluorocarbons, chlorocarbons, and chlorofluorocarbons. Examples of fluorocarbons include methyl fluoride, perfluoromethane, ethyl fluoride, 1,1-difluoroethane (HFC-152a), 1,1,1-trifluoroethane (HFC-143a), 1,1,1,2-tetrafluoro-ethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, and perfluorocyclobutane. Partially halogenated chlorocarbons and chlorofluorocarbons for use in this invention include methyl chloride, methylene chloride, ethyl chloride, 1,1,1-trichloroethane, 1,1-dichloro-1-fluoroethane (HCFC-141b),1-chloro-1,1-difluoroethane (HCFC-142b), chlorodifluoromethane (HCFC-22), 1,1-dichloro-2,2,2-trifluoroethane (HCFC-123) and 1-chloro-1,2,2,2-tetrafluoroethane (HCFC-124), and the like. Fully halogenated chlorofluorocarbons include trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. Chemical blowing agents include azodicarbonamide, azodiisobutyro-nitrile, benzenesulfonhydrazide, 4,4-oxybenzene sulfonyl-semicarbazide, p-toluene sulfonyl semi-carbazide, barium azodicarboxylate, and N,N′-dimethyl-N,N′-dinitrosoterephthalamide and trihydrazino triazine. In the present invention it is preferable to use 8 to 14% by weight based on the weight of the polymer HCFC-142b or 4 to 12% of HFC-134a with 0 to 3% ethanol. Alternatively 3 to 8% carbon dioxide with 0 to 4% lower alcohol, which include ethanol, methanol, propanol, isopropanol and butanol.

Optional additives which may be incorporated in the extruded foam product include infrared attenuating agents, plasticizers, flame retardant chemicals, pigments, elastomers, extrusion aids, antioxidants, fillers, antistatic agents, UV absorbers, etc. These optional additives may be included in any amount to obtain desired characteristics of the foamable gel or resultant extruded foam products. Preferably, optional additives are added to the resin mixture but may be added in alternative ways to the extruded foam manufacture process.

The glass fibers can be added directly into the molten polymer during the extrusion process, or pre-blended with polystyrene beads, or pre-compound with polymer to form pellets, or beads before feeding into the extruder.

The board may be prepared by any means known in the art such as with an extruder, mixer, blender, or the like. Once the blowing agent is incorporated and thoroughly melted and mixed with the plastified resin mixture containing asphalt, polymer, infrared attenunating agent and other additives, the resulting composition is referred to as a foamable gel. The foamable gel is then cooled to a die melt temperature, and is extruded into a zone of die pressure resulting in foaming of the gel and formation of the desired extruded foam product.

The melt mixing temperature must be sufficient to plastify or melt the polymer. Therefore the melt mixing temperature is at or above the glass transition temperature or melting point of the polymer. Preferably, in the preferred embodiment, the first temperature is from 200° C. (392° F.) to 260° C. (500° F.), most preferably about 220° C. (428° F.) to 240° C. (464° F.). The die melt temperature is typically cooler than the first temperature. The die melt temperature is preferably, in the preferred embodiment, from 100° C. (212° F.)-130° C. (266° F.), most preferably about 110° C. (230° F.) to about 120° C. (248° F.).

The first pressure must be sufficient to prevent prefoaming of the foamable gel that contains the blowing agent. Prefoaming involves the undesirable premature foaming of the foamable gel before extrusion into a region of reduced pressure. Accordingly, the first pressure varies depending upon the identity and amount of blowing agent in the foamable gel. Preferably, in the preferred embodiment, the first pressure is from 930 psi (6412 kPa)-1100 psi (7584 kPa), most preferably around 1000 psi (6894 kPa).

The second pressure (die pressure) is sufficient to induce conversion of the foamable gel into a foam body. In the preferred embodiment, the die pressure is from 380 psi (2620 kPa)-400 psi (2757 kPa), most preferably around 390 psi (2688 kPa). The expansion ratio, foam thickness/die gap, is in the range of 20 to 70, typically about 60.

In the preferred embodiment, an extruded polystyrene polymer foam is prepared by both twin screw extruder (low shear), and single screw extruder (high shear). Glass fibers are added into the extruder along with polystyrene, a blowing agent, infrared attenuating agents and other optional additives by multi-feeders. The fibers can be uniformly blended throughout the polymer in the extruding process, thus resulting a homogeneous foam structure.

For some applications, compounds with insecticidal properties may be added to the foamable polymer compositions prior to foaming or may be applied to the exterior of the foam sheets in post-treatment processes.

A preferred foam board in accordance with this invention is a closed cell polystyrene board having a density the range of 8 to 80 kg/m³, more preferably in the range of 21.6 to 32 kg/m³, as measured by ASTM D-1622. If desired, one or more faces of the foam board may be grooved or sanded to facilitate drainage and/or the adhesion of coatings, and one or more faces of the foam board may have a film laminated thereto to increase the strength of the board.

### EXAMPLES

Extruded polystyrene foam boards were produced to provide test samples. Concentration of fiberglass, fiber size, fiber type, and density of the sample is listed in Table 1.

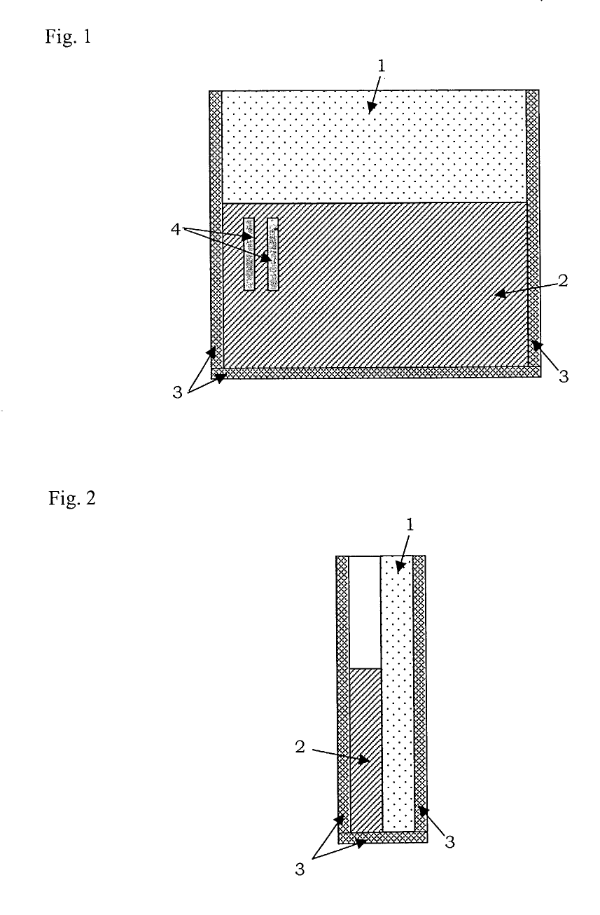

The test samples were exposed to termites at a density of 200 to 300 termites per cubic inch of soil in a clear plastic fixture. The fixture is illustrated in FIGS. 1 and 2, in which reference character 1 denotes a foam sample, reference character 2 denotes potting soil, reference character 3 denotes transparent plastic walls, and reference character 4 denotes slivers of wood.

Three replicates were tested for each fiberglass concentration. Small slivers of pine were provided to the termites to act as a food source. The top of the fixture was covered to help maintain humidity in the fixture. A sponge was used to introduce distilled water to the fixture to maintain humidity. Potting soil was used as a medium for the termites. All samples were covered with a dark plastic sheet between inspections.

Fixtures were inspected for evidence of damage to foam and viability of termites approximately every other day. Any damage found was noted. At the end of 2 months the fixtures were torn down to reveal any hidden damage. Damage was assessed in terms of surface damage to the foam and actual tunnels through the foam.

### SUMMARY OF RESULTS

Results are summarized in Table 1 for all three samples made. Sample 463-1 contained no fiberglass particles and was used as a control.

TABLE 1

| SAMPLE | 463-1 | 463-6 | 461-6 |
|---|---|---|---|
| Density-kg/m³ | 26.27 | 26.11 | 27.72 |
| Cell Size | .289 mm | .242 mm | .249 mm |
| % Fiberglass | None | 8% | 6% |
| Fiberglass Type | | Chopped | Milled |
| Length of Fiber | | 0.15748″ | 0.03125″ |
| Fiber Diameter | | 14 μm | 15.8 μm |
| R per Inch | 5.479 @ 181 days | 5.243 @ 181 days | 5.383 @ 183 days |
| Inches of Surface | 23.5″ | 16″ | 8″ |
| Damage | (Sum of 3 | (Sum of 3 | (Sum of 3 |
| | replicates) | replicates) | replicates) |
| Tunnels Through | 5 | 1 | None |
| Sample | (Sum of 3 replicates) | (Sum of 3 replicates) | (Sum of 3 replicates) |

The 463-1 series (control) is most consistent, in that all samples have damage. 463-1-A: approximately 14 inches (355.6 mm) of material was removed on the bottom and back and side, with one hole through the foam. 463-1-B: approximately 11 inches (279.4 mm) of material removed from the bottom and side. 463-1-C: approximately 8.5 inches (215.9 mm) of material removed on bottom and back, with one hole through the foam. Overall: 463-1-A shows evidence of two real tunnels in addition to surface material removal; 463-1-B shows edge surface removal; and 463-1-C shows evidence of 2 (possibly 3) real tunnels in addition to surface damage.

The 461-6 series (milled fiberglass) showed large damage on only one sample. 461-6-A: approximately 0.5 inch (12.7 mm) of foam removed on back side. 461-6-B: approximately 7.5 inches (190.5 mm) of tunnel noted on back surface. 461-1-C: no damage on back side. Overall, no evidence of material removed on dirt side. No tunneling from dirt side except removal of foam from edges of sample.

The 463-6 series (chopped fiberglass) showed the least damage overall. 463-6-A: approximately 3.5 inches (88.9) of surface tunnel on backside, and material removed from two 0.5 inch (12.7 mm) spots on bottom. 463-6-B: approximately 3.5 inches (88.9 mm) of material removed on back. 463-6-C: approximately 8 inches (203.2 mm) total bottom surface removed. Overall, no evidence of material removed on dirt side (except for slight mark, possible start of a tunnel, on dirt side of 463-6-C). No tunneling from dirt side except removal of foam from edges of sample.

The data reported in the Table establishes that the introduction of fiberglass into the foam board—samples 463-6 and 461-6—reduces attack by termites. Also, thermal values remain within specification (ASTM C-578). Concentration levels and fiber size can affect results and may be optimized in accordance with the principals of this invention. However, as the table shows, both of the levels, sizes, and types of fiberglass fiber tested significantly reduced damage in the test samples.

The invention being thus described, it will be apparent that the same may be varied in many ways. Such variations are not to be regarded as departing from the spirit and scope of the invention, and all such modifications as would be obvious to one skilled in the art are intended to be included within the scope of the following claims.

What is claimed is:

1. A polystyrene foam board comprising from 2 to 25 weight-% acicular particles.

2. The polystyrene board of claim 1, comprising from 5 to 10 weight-% acicular particles.

3. The polystyrene board of claim 1, wherein said acicular particles are are fibers ranging in size from 0.0156 inch (0.396 mm) inch to 0.5 inch (12.7 mm) in length and 10 to 20 micrometers in diameter.

4. The polystyrene board of claim 1, wherein said polystyrene foam is a closed cell foam having a density from 8 to 80 kg/m³.

5. The polystyrene board of claim 4, wherein said polystyrene foam has a density from 21.6 to 32 kg/m³.

6. The polystyrene board of claim 4, wherein the board has a thickness of at least 0.5 inch (12.7 mm) and an average cell size of at least 0.1 mm.

7. The polystyrene board of claim 1, wherein the acicular particles are selected from the group consisting of fiberglass, stone wool, metal wool, gypsum, quartz and wollastonite or combinations thereof.

8. An insect resistant extruded foam board comprising: a foamable polymer, compounding additives, blowing agent, and glass fibers.

9. The insect resistant extruded foam board of claim 8, further comprising:
at least one process additive selected from the group consisting of nucleation agents and flame retardant chemicals.

10. The insect resistant extruded foam board of claim 8 wherein the foamable polymer is a polymer blend comprising: alkenyl aromatic polymers having weight-average molecular weights from about 30,000 to about 500,000.

11. The insect resistant extruded foam board of claim 10 wherein the foamable polymer is a polymer blend comprising polystyrene.

12. The insect resistant extruded foam board of claim 8 wherein the blowing agent is an inorganic blowing agent selected from the group consisting of carbon dioxide, nitrogen, argon, water, air, nitrogen, and helium.

13. The insect resistant extruded foam board of claim 8 wherein the blowing agent is an organic blowing agents selected from the group consisting of aliphatic hydrocarbons having 1-9 carbon atoms, aliphatic alcohols having 1-3 carbon atoms, and fully and partially halogenated aliphatic hydrocarbons having 1-4 carbon atoms.

14. The insect resistant extruded foam board of claim 8 wherein the blowing agent comprises a mixture of organic blowing agents and inorganic blowing agents.

15. The insect resistant extruded foam board of claim 8, comprising up to 25 weight percent glass fibers.

16. The insect resistant extruded foam board of claim 8, wherein said glass fibers are fibers ranging in size from 0.0156 inch (0.396 mm) inch to 0.5 inch (12.7 mm) in length and 10 to 20 micrometers in diameter.

17. A method of forming a termite resistant extruded foam board comprising the steps of:
forming a foamable mixture of polymer, compounding additives, acicular particles and blowing agent under a pressure sufficient to prevent prefoaming of the mixture, and
foaming the mixture in a region of atmospheric or sub-atmospheric pressure to form the foam product.

18. The method of forming a termite resistant extruded foam board of claim 17, further comprising the steps of:
adding at least one process additive selected from the group consisting of nucleation agents and flame retardant chemicals to the foamable mixture.

19. The method of forming a termite resistant extruded foam board of claim 17, wherein the acicular particles form up to up to 25 weight percent of the foamable mixture.

20. The method of forming a termite resistant extruded foam board of claim 19, wherein the acicular particles are fibers ranging in size from 0.0156 inch (0.396 mm) inch to 0.5 inch (12.7 mm) in length and 10 to 20 micrometers in diameter.

21. The method of forming a termite resistant extruded foam board of claim 17, further comprising the step of milling the acicular particles prior to the step of forming the foamable mixture.

22. The method of forming a termite resistant extruded foam board of claim 17, further comprising the step of chopping the acicular particles prior to the step of forming the foamable mixture.

23. The method of forming a termite resistant extruded foam board of claim 17, wherein the acicular particles are selected from the group consisting of fiberglass, stone wool fibers, metal wool, gypsum, quartz and wollastonite or combinations thereof.
